(19) United States
(12) Patent Application Publication
(10) Pub. No.: US 2008/0029374 A1
(43) Pub. Date: Feb. 7, 2008

(54) SWITCH AND METHOD FOR OPERATION THEREOF

(75) Inventors: Stephen M. Christopher, Chicago, IL (US); Ryan P. Rye, Duluth, GA (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/459,611

(22) Filed: Jul. 24, 2006

(51) Int. Cl. H01H 3/02

(52) U.S. Cl. 200/329

(57) ABSTRACT

A combination sliding push button switch is disclosed. The combination switch comprises a sliding button switch (101) coupled to a housing (102). The sliding switch button includes a finger (202) that slideably couples the sliding switch button to the housing and the finger has an actuator portion that selectively engages a second switch 108 as a function of a sliding action of the sliding switch button relative to the housing. The sliding switch button moves with a push-button motion in direction perpendicular to the sliding action in order to engage a popple dome switch 106 when the sliding switch button is positioned in a first sliding position 300 relative to the housing.

### FIELD OF THE DISCLOSURE

The present disclosure relates generally to switches and more particularly to a combination push-button slider switch.

### BACKGROUND OF THE DISCLOSURE

Electronic devices such as wireless headsets have a minimal number of buttons to control the device yet at the same time reduce the complexity that increases with the increase in the number of buttons. There is generally a power switch to turn the unit on and off which also doubles as a mode selection switch and then volume control switches for a total of three buttons. The power/mode selection button is pressed a first time to power the device up and then once powered up, the button is used to control the device. Additionally some of these wireless headsets are carried directly on the ear, having fewer buttons provides for an ease of operation as the user does not need to feel around for the proper button. However, keeping the three button design while improving functionality becomes difficult.

Most headsets on the market that have a power on-off functionality integrated with the interface of the push button (e.g. press-and-hold). Having multiple features located into one single action button and in addition having timed holds for other function and light indication creates a confusing product and leads to unintended actuation.

Other solutions attempt to solve this problem with the addition of switches and/or non wearable mechanisms. These devices create a more confusing interface for the user and most products and in addition cannot be used blindly.

The various aspects, features and advantages of the present disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

The present invention is illustrated by way of example and not limitation in the accompanying figures, in which like references indicate similar elements.

FIG. 1 illustrates an exemplary top perspective view of the combination sliding button switch.

FIG. 2 illustrates an exemplary bottom perspective view of the combination sliding button switch.

FIG. 3 illustrates an exemplary cross sectional view of the switch in a first position.

FIG. 4 illustrates an exemplary cross sectional view of the switch in a first position.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

In general, a combination sliding pushbutton switch is disclosed. The combination switch comprises a sliding switch button coupled to a housing. The sliding switch button includes a finger that slideably couples the sliding switch button to the housing and the finger has a actuator portion that selectively engages a first switch as a function of a sliding action of the sliding switch button relative to the housing. The sliding switch button moves with a push-button motion in direction perpendicular to the sliding action in order to engage a popple dome switch when the sliding switch button is positioned in a first sliding position relative to the housing. In one embodiment a leaf spring is coupled between the sliding switch button and the housing. The leaf spring returns the sliding switch button to a first button position from a second depressed button position. The sliding action of the sliding switch button turns the device on and off. The push-button motion controls the device and the operation performed depends on the time the button is pushed and the duration that the button is pushed.

Before describing in detail embodiments that are in accordance with the present invention, it should be observed that the present invention resides primarily in combinations of method steps. Accordingly, the method steps have been represented where appropriate by conventional symbols in the drawings, showing only those specific details that are pertinent to understanding the present invention, so as not to obscure the disclosure with details that will be readily apparent to those of ordinary skill in the art, having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

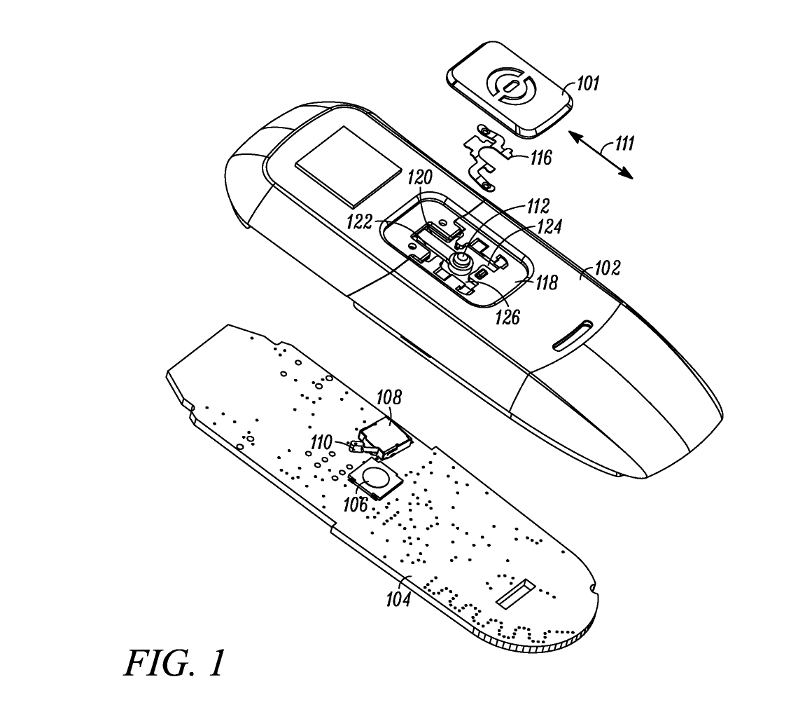

FIG. 1 illustrates an exemplary top perspective view of the combination sliding button switch. The sliding switch button 101 is slideably carried by a housing 102. The housing 102 carries a circuit board 104 which includes a first switch 106 and a second switch 108. The first switch 106 is activated by a first activation method and the second switch 108 is activated by a second activation method. The first switch 106 is a control switch that controls the mode of the device or activates certain features of the device. The second switch 108 is a power switch for turning the power on and off. The first switch 106 is physically disabled when the sliding switch button is in the powered off configuration. The housing includes a popple dome actuator arm 112. The popple dome actuator arm 112 extends between the sliding button switch 101 and the first switch 106. The popple dome actuator arm 112 bends such that when the sliding button switch is depressed toward the circuit board 104, the sliding button switch 101 engages the popple dome actuator arm 112, which then in turn engages the first switch 106.

The combination sliding button switch, in one embodiment, includes a leaf spring 116 to return the button to a first position after the sliding button switch 101 has been depressed and then released by the user. It is understood that other button return apparatus may be employed to return or maintain the sliding button switch in the undepressed or off position. For example, the sliding button switch 101 may be made of a material that allows the sliding button switch 101 to naturally form or return back to the undepressed form. Or in another embodiment a coil spring may be placed between the sliding button switch 101 and the circuit board or the like in order to return the sliding button switch 101 to the undepressed position.

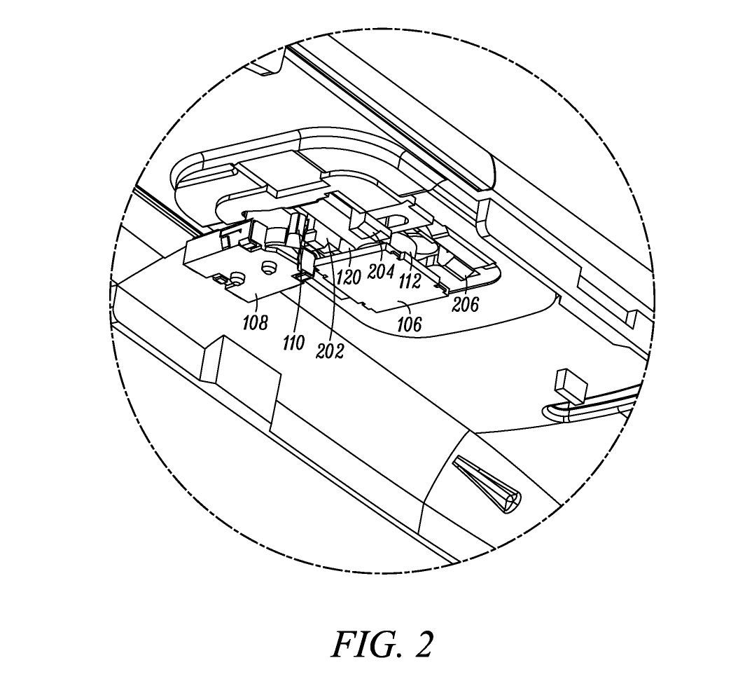

The sliding switch button 101 slides back in forth in this embodiment in the directions indicated by the arrow 111. The sliding switch button slides relative to the housing 102 in slots 120, 122, 124 and 126 which are voids in the housing 102. FIG. 2 illustrates an exemplary bottom perspective view of the combination sliding button switch. Fingers 202, 204 and 206 couple the sliding button switch 101 to the housing 102. In this embodiment the sliding switch button 101 slides within a recessed area 118 of the housing 102. The first finger 202 engages a toggle arm 110 of the second switch 108 as a result of the sliding action of the sliding button switch 101. When the sliding button switch 101 is slid away from the first switch the toggle arm of the second switch toggles the first switch 106 to the off or open circuit position. When the sliding button switch 101 is slid toward the first switch, the toggle arm 110 if the second switch toggles to the on or closed circuit position completing the circuit and turning on the device.

The sliding button switch 101 also moves in a second direction, different than the direction of the sliding motion. In this embodiment, the sliding button switch 101 moves perpendicular in a push-button motion in order to engage the first switch 106. In this embodiment the first switch is a popple dome switch 106 which is activated by motion perpendicular to the first switch 106.

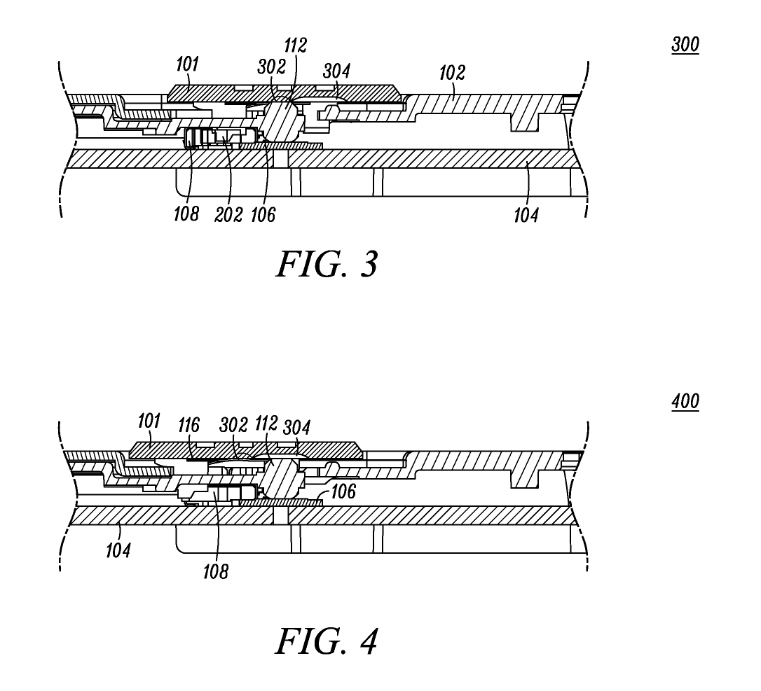

A cross sectional view of the sliding button switch 101 in the “on” configuration 300 is illustrated in the exemplary embodiment shown in FIG. 3. The sliding button switch 101 may only be depressed when the sliding button switch is in the “on” configuration 300 in order to activate the first switch 106. The sliding button switch 101 has a first switch activation portion 302 which engages the popple dome actuator arm 112. When the sliding button switch 101 is aligned in the “on” configuration 300 the first switch activation portion 302 aligns and engages with the popple dome actuator arm 112 which then activates the popple dome switch 106. In this embodiment the popple dome switch 106 is a momentary switch and is used to control the device operation including mode of operation.

FIG. 4 illustrates an exemplary cross sectional view of the switch 101 in a second position which in this embodiment is an off position. In this embodiment the second switch 108 is engaged by the finger 202 and toggled to the off position. In the off position the void 304 in the sliding button switch 101 is aligned with the popple dome actuator arm 112. The sliding button switch 101 can not come into contact with the popple dome actuator arm 112 in order to actuate the popple dome switch, preventing the first switch from being activated when the sliding button switch 101 is in the off position.

A method of operation, in a Bluetooth headset for example comprises, sliding the sliding button switch 101 to the on position 300. Then depressing the sliding button switch in a push button motion to activate the popple dome switch 106. In one embodiment activating the popple dome switch 106 immediately after turning the power on puts the Bluetooth headset in discovery mode for example. Holding the sliding button switch 101 down for a period of one second activates a call session. After the call session, the user may depress the sliding button switch 101 momentarily to end the call session. The user may then slide the sliding button switch to the off position to turn the Bluetooth headset off.

While the present disclosure and the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A combination push button sliding switch comprising:
a housing having circuit board housed therein;
a first switch carried on the circuit board;
a second switch carried on the circuit board;
a sliding switch button slideably coupled to the housing, the sliding switch button configured to selectively engage the first switch and the second switch;
a finger extending from the sliding switch button that slideably couples the sliding switch button to the housing and the finger has an actuator portion, wherein the actuator portion selectively engages the first switch as a function of a sliding action of the sliding switch button relative to the housing; and
an actuator arm coupled between the sliding switch button and the second switch, wherein
the sliding switch button moves with a push-button motion in direction perpendicular to the sliding action in order to engages a popple dome switch when the sliding switch button is positioned in a first sliding position relative to the housing.
